(19) United States
(12) Patent Application Publication
(10) Pub. No.: US 2023/0203292 A1
(43) Pub. Date: Jun. 29, 2023

(54) REACTIVE FLUOROPOLYMER COMPATIBILIZER AND USES THEREOF

(71) Applicants: DAIKIN AMERICA, INC., Orangeburg, NY (US); DAIKIN INDUSTRIES, LTD., Osaka (JP)

(72) Inventors: Arthur MARTIN, Decatur, AL (US); Halie Jill Martin, Huntsville, AL (US); Anna Veronica Walter, Huntsville, AL (US); Kyle Ptak, Decatur, AL (US); Dakarai Kameron Brown, Hopkins, MN (US)

(73) Assignees: DAIKIN AMERICA, INC., Orangeburg, NY (US); DAIKIN INDUSTRIES, LTD., Osaka (JP)

(21) Appl. No.: 18/177,832

(22) Filed: Mar. 3, 2023

Related U.S. Application Data
(63) Continuation of application No. PCT/JP2021/032454, filed on Sep. 3, 2021.
(60) Provisional application No. 63/074,646, filed on Sep. 4, 2020.

(51) Int. Cl. C08L 23/28; C08L 67/04

(52) U.S. Cl. CPC C08L 23/28; C08L 67/04

(57) ABSTRACT

A reactive polymer compatibilizer and compatibilized polymer blends are provided. The reactive polymer compatibilizer is generally a copolymer of a fluoropolymer and a non-fluoropolymer that improves the miscibility of fluoropolymers and non-fluoropolymers. The compatibilized polymer blend contain a fluoropolymer, non-fluoropolymer, and reactive polymer compatibilizer. In some embodiments, the reactive polymer compatibilizer may be tailored to achieve desirable characteristics in the compatibilized polymer blends.

### CROSS-REFERENCE TO RELATED APPLICATIONS

This application is a Rule 53(b) Continuation of International Application No. PCT/JP2021/032454 filed Sep. 3, 2021, which claims priority based on U.S. Provisional Pat. Application No. 63/074,646, filed Sep. 4, 2020, the respective disclosures of all of which are incorporated herein by reference in their entirety.

### TECHNICAL FIELD

The present disclosure relates generally to thermoplastics, and specifically to blends and co-polymers of fluoropolymers and other non-fluorinated polymers, methods of their productions, and uses thereof.

### BACKGROUND ART

This section is intended to introduce the reader to various aspects of the art that may be related to various aspects of the presently described embodiments-to help facilitate a better understanding of various aspects of the present embodiments. Accordingly, it should be understood that these statements are to be read in this light, and not as admissions of prior art.

Thermoplastic polymers exhibit a wide range of thermal, mechanical, and electrical properties. Many engineering polymers have been developed to address modern technical challenges and material needs, including, for example, poly(ether ether ketone), polyetherimides, liquid crystalline polymers, and fluoropolymers. Among different polymers, each shows different properties, leading to their use in different applications. For example, fluoropolymers typically have low dielectric constants and dielectric losses, and so are typically used in applications such as wiring for aerospace systems. Polyetherimides have high thermal resistance, and so are typically used in under-the-hood applications in automobiles. However, there are applications that require multiple properties that are not present in one material alone. For example, in wire and cable insulation, the toughness of fluoropolymers is often not sufficient, while the flexibility or elongation of polyetherimides may also be lacking. By combining two different polymers with different properties, one material that meets a variety of specifications can be obtained.

A large number of commercial polymeric products are derived from the blending of two or more polymers to achieve a desirable balance of physical properties. However, since many polymer blends are immiscible, it may be challenging to identify two or more polymers that are miscible and have the desired characteristics.

Polymer-polymer mixtures are, in general, less miscible than mixtures of small molecules. Due to the higher molecular weight of polymers, the entropic contribution to the free energy of mixing is limited. This means that the miscibility of polymer blends depends on the interactions that occur between the polymer repeat units. As a result, dissimilar polymers are often immiscible across a wide range of temperatures. This can lead to bulk-scale phase separation of polymer blends and consequently, poor performance of those polymer blends.

Many processed polymer mixes consist of a dispersed phase in a more continuous matrix of another component. The formation, size, and concentration of this dispersed phase are typically optimized for specific mechanical properties. If the morphology is not stabilized, the dispersed phase may coalesce under heat or stress from the environment or further processing. This coalescence may result in undesirable properties (e.g., brittleness and discoloration) due to the induced phase separation.

This phase separation can be overcome in a few ways. One method is the creation of block co-polymers. While block co-polymers may still phase separate, the phases formed are typically micro-phases. The structure of these phases can, in some cases, enhance polymer properties. Another method is the use of small molecule compatibilizers. The use of small molecule compatibilizers is similar to the use of surfactants to stabilize small molecule mixtures.

One processing technique that can be used to achieve compatible blends is reactive extrusion, or reactive mixing. Reactive compatibilization is the process of modifying a mixed immiscible blend of polymers to arrest phase separation and allow for the formation of a stable, long-term continuous phase. There are at least a few chemical pathways by which this can be achieved. One is via the addition of a reactive polymer, miscible with one blend component and reactive towards functional groups on the second component, which result in the “in-situ” formation of block or grafted copolymers. A common technique involves functionalizing one monomer. For example, Nylon-rubber bands are polymerized with functionalized rubber to produce graft or block copolymers. The added structures make it no longer favorable to coalesce and/or increase the steric hindrance in the interfacial area where phase separation would occur. Another chemical pathway is the compatibilization of polymer blends by means of reactive coupling agents. Reactive coupling agents can be added into polymer blends during melt processing. Performant linkages between coupling agents and target polymers may be formed at elevated temperatures, leading to a high compatibilization effect. Coupling agents include a variety of reactive groups: silane, carbodiimide, isocyanate, bisoxazoline, biscaprolactam, epoxide, anhydride, as well as catalysts for interchange reactions.

The creation of block-copolymers via reactive extrusion, as well as the compatibilization of polymer blends via reactive extrusion and / or small molecule compatibilizers has been limited to what would often be called commodity, non-fluorinated, polymers such as polyethylene (both high and low-density), polypropylene, polybutadiene, polyacrylonitrile, polystyrene, polyamide, poly vinyl chloride (PVC), polyesters, and copolymers of the same such as ABS, SAN, and SBR. However, these materials do not often offer as many benefits for extreme applications as engineering polymers. Engineering polymers include, for example, fluoropolymers, poly (ether ether ketone) (PEEK), polyimides, polyetherimides, cyclic olefin copolymers (COCs), polyphenylene oxide (PPO, also called polyphenylene ether or PPE), and liquid crystalline polymers (LCPs). The compatabilization of engineering polymers, with a focus on fluoropolymer blends with other engineering polymers is discussed herein.

Fluoropolymers are typically electrically stable and less sensitive to high frequency electronic signals than other polymers. Fluoropolymers such as PTFE, PFA and FEP have lower dielectric constants and lower loss than most plastics. For this reason, they are widely used for applications such as electrical insulation materials, coaxial cable, robot wiring and printed circuit board. Fluoropolymers are widely used in automotive, aerospace, semiconductors, electronics, and common household appliances because of their unique non-adhesive and low friction properties as well as their superior heat, chemical and weather resistance and superior electrical properties compared with the other polymers. However, there are drawbacks to fluoropolymers. Fluoropolymers typically have lower toughness and adhesion than other polymers. Therefore, it may be desirable to blend fluoropolymers with non-fluorinated polymers to overcome these drawbacks. What is needed is a method to create a block-copolymer that serves as a compatibilizing agent for polymer blends.

### SUMMARY

This disclosure relates generally to the creation of a block-copolymer that serves as a compatibilizing agent for polymer blends, generally referred to as a reactive polymer compatibilizer.

In some embodiments, a reactive polymer compatibilizer comprises a fluoropolymer segment and a non-fluoropolymer. A “segment” may include a polymer, a portion of a polymer, an oligomer, or a monomer. The reactive polymer compatibilizer is compatible with fluoropolymers and non-fluoropolymers. Methods for forming the reactive polymer compatibilizers are described herein. In some embodiments, the reactive polymer compatibilizer is a co-polymer made from a functional fluoropolymer, functional monomers, functional oligomers, and/or a functional non-fluoropolymer. The formation of a reactive polymer compatibilizer may have many permutations in which the active participant includes a functional fluoropolymer. Disclosed embodiments may have a functional fluoropolymer with functional monomers, a functional fluoropolymers with functional oligomers, a functional fluoropolymer with functional non-fluoropolymers, or any combination of the above. The reactive polymer compatibilizers of the present invention render desirable mechanical properties when added to fluoropolymers and/or non-fluoropolymers because of increased miscibility of the total blend.

Some embodiments relate to a compatibilized polymer blend comprising a fluoropolymer, non-fluoropolymer, and a reactive polymer compatibilizer, wherein the reactive polymer compatibilizer is a block-copolymer including a fluoropolymer block and a non-fluoropolymer block.

Articles made using the disclosed reactive polymer compatibilizers and compatibilized blends show improved mechanical properties and performance due to the improved miscibility of fluoropolymers in the polymer blends. In some embodiments, the disclosed reactive polymer compatibilizers improve the processability of materials and the quality of polymer pellets formed.

### BRIEF DESCRIPTION OF DRAWINGS

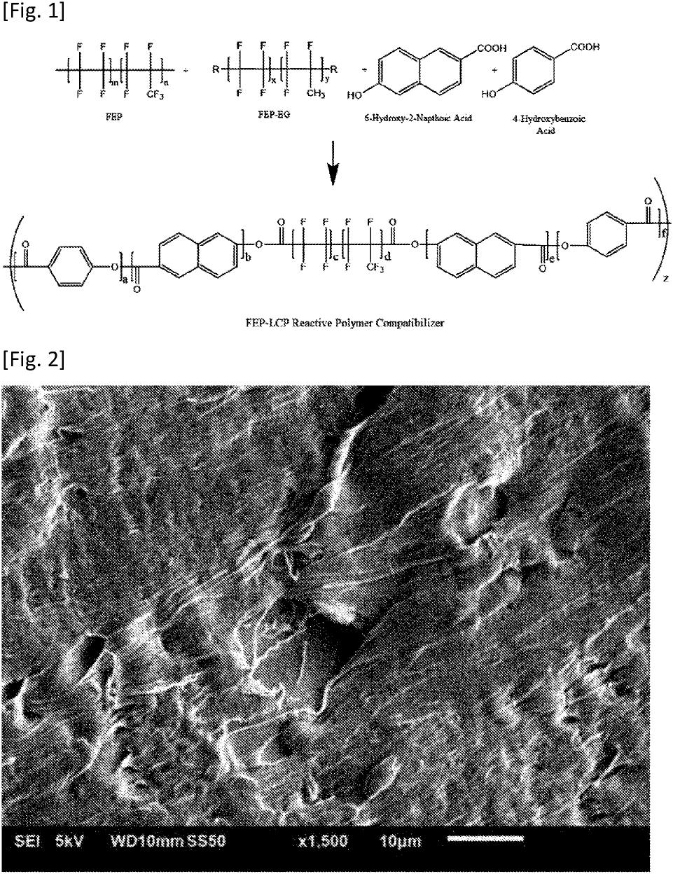

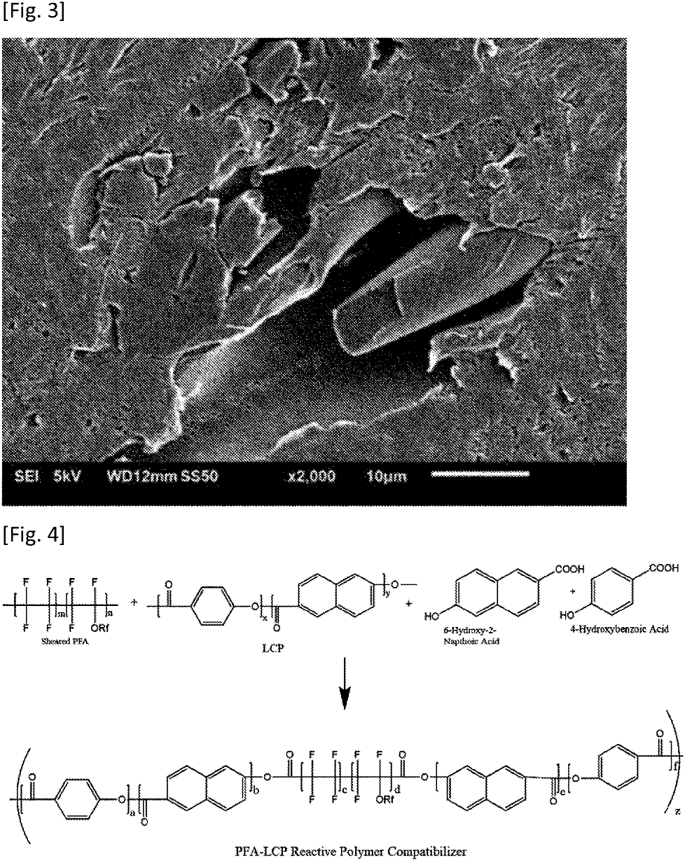

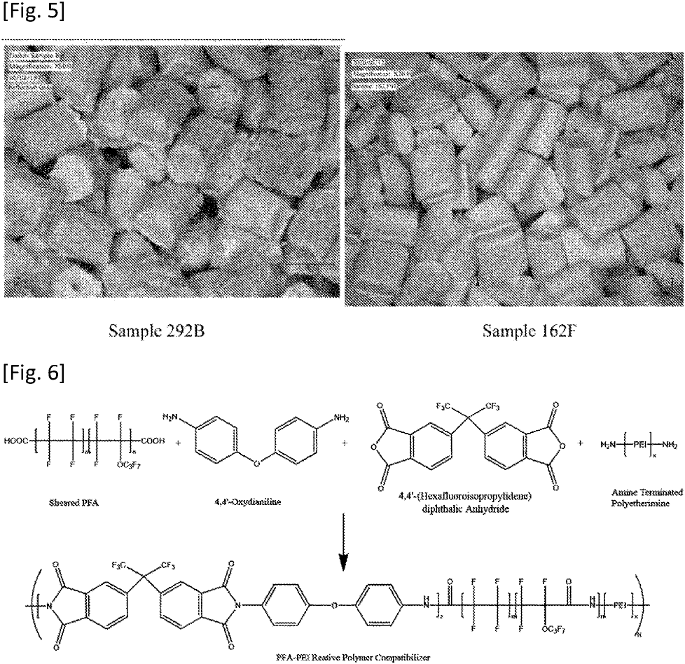

The accompanying drawings incorporated in and forming a part of this specification illustrate several aspects of the disclosure, and together with the description serve to explain the principles of the disclosure.

[FIG. 1] FIG. 1 illustrates a potential synthesis of a reactive polymer compatibilizer according to one embodiment.

[FIG. 2] FIG. 2 shows a scanning electron micrograph image of an embodiment of a reactive polymer compatibilizer at 1,500× magnification.

[FIG. 3] FIG. 3 shows a scanning electron micrograph image of an embodiment of a reactive polymer compatibilizer at 2,000× magnification.

[FIG. 4] FIG. 4 illustrates a potential synthesis of a reactive polymer compatibilizer according to one embodiment.

[FIG. 5] FIG. 5 shows photographs comparing pellets of a compatibilized polymer blend an a control polymer blend.

[FIG. 6] FIG. 6 illustrates a potential synthesis of a reactive polymer compatibilizer according to one embodiment.

### DESCRIPTION OF EMBODIMENTS

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

Disclosed herein is a reactive fluoropolymer compatibilizer for improving the blending of fluoropolymers with non-fluoropolymers. Most fluoropolymers are immiscible with other polymers and therefore many blends of fluoropolymers may not impart the desired properties and/or allow for engineered tunable properties to suit the desired application. In many cases, fluoropolymers such as PTFE, PFA and FEP are added to a non-fluoropolymer to improve flammability, reduce moisture absorption, or improve lubricity.

Herein, we disclose a reactive polymer compatibilizer copolymer that may be used to impart new properties to fully compatibilized polymer blends. The reactive polymer compatibilizers may be created using monomers with multi-functionality to create covalent, van der Waals and/or ionic bonds. In some embodiments, covalent bonds may be created through condensation polymerization using monomers with functional groups such as, for example, amide, imide, imine, oxime, hydrazone, ester and/or urethane. In some embodiments, bonds may be formed by addition polymerization when unsaturated bonds react to form saturated bonds. Blends may also be ionic in nature.

In some embodiments, the disclosed reactive polymer compatibilizer is a block co-polymer. Small molecules may react with each other and/or with the reactive end groups of various reactive polymers. The small molecules may be selected to help link two dissimilar reactive polymers together. The reactive end groups used may be those that are natively on the polymer. That is, in some embodiments, no additional reactive or processing steps are necessary to introduce functionality. Additionally, small molecules may be chosen such that once reacted, a short-chain polymer is created. This technique may be used to create either an AB or ABC block copolymer, where A is a fluoropolymer, B is a condensation polymer created from the reaction of the added small molecules, and C is another polymer in the blend. The small molecules can be chosen such that the resulting B block is similar in structure to the C block, or such that the B block adds additional beneficial properties to the blend. The block copolymer can then act as a compatibilizing agent within the blend of the two constituent polymers.

In some embodiments, the compatibilized polymer blend of claim 11, wherein the fluoropolymer is a perfluoroalkoxy alkane (PFA) or a fluorinated ethylene propylene (FEP). In some embodiments, the non-fluoropolymer is a polyetherimide (PEI) or thermoplastic polyimide (TPI). In some embodiments, the non-fluoropolymer is a polyaryle ether ketones (PAEK) or poly ether ether ketone (PEEK). In some embodiments, the non-fluoropolymer is a Polyphenylene Oxide (PPO) polymer or a Cyclic Olefin (COC) polymer.

Some disclosed embodiments relate to a method of forming a reactive polymer compatibilizer comprising reacting a functional fluoropolymer, a first functional monomer, and a functional non-fluoropolymer within an extruder to form a reactive polymer compatibilizer. In some embodiments, the method further comprises reacting a functional segment or oligomer within an extruder. In some embodiments, the method further comprises extruding the reactive polymer compatibilizer and/or forming pellets of the reactive polymer compatibilizer.

### EXAMPLE

### Example 1: Preparation of FEP/LCP Reactive Polymer Compatibilizer

Various embodiments of reactive polymer compatibilizers may be described in terms of the polymers they are designed to compatibilize. For example, a reactive polymer compatibilizer designed to increase the miscibility between fluorinated ethylene propylene (FEP) and a liquid crystal polymer (LCP) may be referred to as an FEP/LCP reactive polymer compatibilizer.

In one example, to form an FEP/LCP reactive polymer compatibilizer, a fully fluorinated FEP, a carboxylated FEP, 6-hydroxy-2-naphthoic acid, and 4-hydroxybenzoic acid were all added to one bag and mixed uniformly. The amounts of each chemical used in the reactive polymer compatibilizers are shown in Table 1. The 6-hydroxy-2-napthoic acid and 4-hydroxybenzoic acid are LCP monomers and were both added at one-to-one molar equivalents. The LCP monomers totaled 5 wt % of all formulations in this Example 1. The carboxylated FEP was varied in each sample from 0 to 75 wt % in samples. [Table 1]

TABLE 1

Amounts of Chemicals Used in FEP/LCP Compatibilized Copolymer

| Reactive Polymer Compatibilizer Sample # | FEP | | LCP Monomers | |
|---|---|---|---|---|
| | Carboxylated FEP (g) | Fully Fluorinated FEP (g) | 6-Hydroxy-2-Naphthoic Acid (g) | 4-Hydroxybenzoic Acid (g) |
| 122A | N/A | 95% (2850 g) | 2.9 wt % (86.5 g) | 2.1 wt % (63.5 g) |
| 122D | 10% (300 g) | 85% (2350 g) | 2.9 wt % (86.5 g) | 2.1 wt % (63.5 g) |
| 123C | 25 % (500 g) | 70% (1400 g) | 2.9 wt % (57.7 g) | 2.1 wt % (42.3 g) |
| 123B | 50 % (1000 g) | 45% (900 g) | 2.9 wt % (57.7 g) | 2.1 wt % (42.3 g) |
| 123A | 75 % (1500 g) | 20% (400 g) | 2.9 wt % (57.7 g) | 2.1 wt % (42.3 g) |

Once the samples were thoroughly mixed, the mixture was fed at 4.0 to 6.0 kg/hr into a twin screw extruder (Leistritz ZSE 18 HP). Extruder zones 1 through 8 were heated from 310° C. to 340° C. for sample 122A. For the remaining reactive polymer compatibilizers, zones 1 through 8 were heated from 300° C. to 310° C. to reduce any possible degradation due to heat. The screw speed was kept constant at 250 rpm. All reactive polymer compatibilizers were obtained as brown pellets.

FIG. 1 shows an example of a scheme for producing the FEP/LCP reactive polymer compatibilizer. As shown in FIG. 1, the preparation of the FEP/LCP reactive polymer compatibilizer occurs via polycondensation in the twin screw extruder. The step growth polycondensation is driven by the heat of the extruder. The HF produced by the fully fluorinated FEP and/or carboxylated FEP also serves a Lewis acid driving the reaction. The aromatic monomers, 6-hydroxy-2-naphthic acid and 4-hydroxybenzoic acid, are effective in lowering the interfacial tension between the fully fluorinated FEP and LCP polymer in the polymer blend. Due to 6-hydroxy-2-naphthoic acid and 4-hydroxybenzoic acid being A-B type functional monomers, both monomers can polymerize with another molecule of the sample molecular structure or other monomer.

After the extrusion of the FEP/LCP reactive polymer compatibilizer samples, the morphologies of sample 122A and sample 123A were compared by scanning electron microscopy (SEM). These two samples were chosen for comparison because of the differences in content of carboxylated FEP. The SEM images were obtained from a Joel JSM-6010Plus SEM. Cross-sections of the samples were prepared and imaged at a working distance of 10 mm using 5 kV. All images were taken between 1.0 k and 2.0 k.

FIG. 2 is a SEM image of sample 122A at 1500× magnification. The image of FIG. 2 shows the presence of fibril morphology. FIG. 3 is a SEM image of sample 123A at 2000× magnification. The image of FIG. 3 shows a continuous phase and no fibrillation morphology observed throughout the sample. This indicates that sample 123A is a continuous AB and ABA block copolymer.

### Example 2: Preparation of FEP/LCP Compatibilized Blends

After the FEP/LCP reactive polymer compatibilizer samples from Example 1 were made, sample 123A was blended in a twin screw extruder with LCP, fully fluorinated FEP, and 1,1′-Carbonyldiimidazole (CDI). Samples 141H has no reactive polymer compatibilizer added. The amounts of each component used in the various samples are shown in Table 2 below.

TABLE 2

Amounts of Components Used in FEP/LCP Compatibilized Blends

| Sample # | LCP | 123A | CDI | Fully Fluorinated FEP |
|---|---|---|---|---|
| 125A | 15% (300 g) | 15% (300 g) | 0.1% (2 g) | 69.9% (1398 g) |
| 125B | 5% (100 g) | 15% (300 g) | 0.1% (2 g) | 79.9% (1598 g) |
| 125C | 5% (100 g) | 5% (100 g) | 0.1% (2 g) | 89.9% (1798 g) |
| 125D | 15% (300 g) | 5% (100 g) | 0.1% (2 g) | 79.9% (1598 g) |
| 1291 | 10% (150 g) | 20% (400 g) | 0.2% (4 g) | 72.3% (1446 g) |
| 141H | 15% (300 g) | 0% | 0.1% (2 g) | 79.9% (1698 g) |

In all samples for this Example 2, the 123A component served as a reactive polymer compatibilizer. The reactive polymer compatibilizer lowered the interfacial tension between the LCP and the fully fluorinated FEP and increased the molecular adhesion between the LCP and the fully fluorinated FEP to achieve a homogeneous blend. In addition to increasing the miscibility between the LCP and the fully fluorinated FEP by using a reactive polymer compatibilizer, CDI was employed as a reactive small molecule compatibilizer in these formulations due to its ability to react with the alcohol end groups to create a new ester bond and the carboxylic acid end groups to create a new anhydride bond.

### Example 3: Mechanical and Thermal Properties of the FEP/LCP Compatibilized Blends

The mechanical and thermal properties of samples 125A, 125B, 125C, 125D, 129I, and 141H (shown in Table 2 above) were tested and compared to fully fluorinated FEP and LCP. The samples were gravity fed into a Sumitomo SE75DU injection molding machine. The rotating screw was heated from 304° C. to 327° C. The samples were molded into ASTM D638 Type V bars for tensile testing, ASTM D790 flexural bars for dynamic mechanical analysis (DMA), and 3 × 3 cm plaques for thermal mechanical analysis (TMA) testing.

Tensile tests were completed according to ASTM D638 using Type V tensile bars and an Instron machine model 3365. All samples were pulled at 10 mm/min until break. The BlueHill2 program was used to calculate the Young’s modulus (YM), tensile strength, and elongation. Table 3 below shows the results of the tensile tests. The data represent the average of four tensile bars.

Samples 125B, 125C, and 129I also underwent testing to calculate flexural modulus, maximum flexure load, and flexure stress. Each of these flexural tests were performed according to ASTM D790 using a calibrated Instron and injection molded ASTM D790 flexural bars. The samples were placed on top of two metal rollers 50 mm apart in the Instron. A rod was utilized to provide a load at a rate of 1.35 mm/min. The BlueHill2 computer program was used to calculate flexural modulus, maximum flexure load, and flexure stress at maximum flexure load. The results of these tests are shown in Table 3 below. All data represent one flexural bar.

TABLE 3

Mechanical Properties of FFP/LCP Compatibilized Blends

| Sample# | Young’s Modulus (MPa) | Max Tensile Strength (MPa) | Max Flexural Load (MPa) | Flexural Modulus (MPa) |
|---|---|---|---|---|
| LCP | 2197 | 86 | 166 | 7937 |
| Fully Fluorinated FEP | 219 | 17 | 21 | 166 |
| 125A | 853 | 21 | - | - |
| 125B | 521 | 19 | 23 | 1174 |
| 125C | 512 | 18 | 19 | 941 |
| 125D | 775 | 24 | - | - |
| 129I | 629 | 18 | 29 | 834 |
| 141H | 903 | 23 | 51 | 1945 |

As can be seen in Table 3, most samples showed Young’s modulus (YM) of at least two or three times higher than the Young’s modulus (YM) of the fully fluorinated FEP. The samples also showed an increase in maximum tensile stress when compared to the fully fluorinated FEP. Due to the rigidity of the LCP, elongation decreased for all samples when compared to the fully fluorinated FEP. The 3-point bend test was employed to determine the compatibility of the LCP in the fully fluorinated FEP according to ASTM D790. A control (sample 141H) was run without the addition of a reactive polymer compatibilizer. The LCP control sample showed a maximum flexure load of 166 and a modulus of 1174 Mpa. When the sample 141H control is compared to sample 125B, the maximum flexural load and modulus of 125B are much lower than sample 141H.

Samples 125B, 125C, and 129I also underwent testing to calculate the coefficient of thermal expansion (CTE). CTE was measured by a TA Instruments TMA Q400 using 2.0 to 3.0 µm samples cut from injection molded 3 × 3 cm plaques. Initial sample dimensions were measured using a Mitutoyo series 293 micrometer. All samples were run using the following method: 1: Force 0.100 N; 2: Equilibrate at 45.00° C.; 3: Mark end of cycle 0, 4: Ramp 10.00° C./min to 100.00° C.; 5: Isothermal for 5.00 min; 6: Mark end of cycle 1; 7: Ramp 10.00° C./min to 55.00° C.; 8: Mark end of cycle 2; 9: Ramp 5.00° C./min to 190.00° C.; 10: Mark end of cycle 3; 11: Jump to 30.00° C.; 12: End of method.

CTE, α, was calculated using the following equation:

$$α = \left(1 / {\text{L}}_{0}\right) ⋅ \left(Δ \text{L} / Δ Τ\right)$$

where L₀ represents the initial sample height at 25° C., ΔL represents the change in length in microns (µms), and ΔT represents the change in temperature in degrees Celsius (°C). All samples were measured at change (ΔT) of 5° C. The results of the CTE testing are shown in Table 4 below. All values reported are in the Z direction, perpendicular to the flow direction of the injection molded sample. [Table 4]

TABLE 4

Coefficient of Thermal Expansion for FEP/LCP Compatibilized Blends

| | | | | | | |
|---|---|---|---|---|---|---|
| Mechanical Properties | Unit | Fully Fluorinated FEP | LCP | 125B | 125C | 1291 |
| CTE @80° C. (Z Direction) | ppm | 183 | 115 | 95 | 98 | 98 |
| CTE @100° C. (Z Direction) | ppm | 211 | 170 | 94 | 97 | 94 |
| CTE @120° C. (Z Direction) | ppm | 214 | 88 | 196 | 192 | 193 |
| CTE @150° C. (Z Direction) | ppm | 222 | 88 | 293 | 191 | 288 |
| CTE @180° C. (Z Direction) | ppm | 269 | 174 | 194 | 190 | 284 |

As shown in Table 4, while samples 125B and 129I show an improvement in CTE values when compared to the fully fluorinated FEP, sample 125C shows improvement at all temperatures including 150° C. and 180° C.

### Example 4: Preparation of FEP/LCP Reactive Polymer Compatibilizer Using Sheared FEP

To form the FEP/LCP reactive polymer compatibilizer of this Example 4, a fully fluorinated FEP that has been mechanically sheared, 6-hydroxy-2-naphthoic acid, and 4-hydroxybenzoic acid were all added to one bag and mixed uniformly. The amounts of each chemical used in the reactive polymer compatibilizers is shown in Table 5. The LCP monomers, 6-hydroxy-2-napthoic acid and 4-hydroxybenzoic acid, were both added at one to one molar equivalents and totaled 5 wt % for the formulation. [Table 5]

TABLE 5

Amounts of Chemicals Used in FEP/LCP Compatibilized Copolymer

| | | | |
|---|---|---|---|
| Sample # | Sheared FEP | 6-hydroxy-2-napthoic acid | 4-hydroxybenzoic acid |
| 141E | 95% (950 g) | 2.89% (28.9 g) | 2.11% (21.1 g) |

Once the sample 141E was thoroughly mixed, the mixture was fed at 4.0 to 6.0 kg/hr into a twin screw extruder (Leistritz ZSE 18 HP). Extruder zones 1 through 8 were heated from 270° C. to 325° C. The screw speed was kept constant at 250 rpm.

### Example 5: Preparation of FEP/LCP Compatibilized Blends

After the FEP/LCP reactive polymer compatibilizer sample 141E was made, the reactive polymer compatibilizer was blended in a twin screw extruder with LCP, 141E, sheared fully fluorinated FEP, and 1,1′-Carbonyldiimidazole (CDI) to form compatibilized FEP/LCP blends. Sample 141H has no reactive polymer compatibilizer added. The amounts of each component used in the various samples are shown in Table 6 below. [Table 6]

TABLE 6

Amounts of Components Used in FEP/LCP Compatibilized Blends

| Sample # | LCP | 141E | CDI | Fully Fluorinated FEP |
|---|---|---|---|---|
| 143B | 15% (300 g) | 5% (100 g) | 0.1% (2 g) | 79.9% (1598 g) |
| 147D | 7.5% (150 g) | 15% (300 g) | 0.2% (4 g) | 72.3% (1446 g) |
| 141H | 15% (300 g) | 0% | 0.1% (2 g) | 79.9% (1698 g) |

Once each sample was thoroughly mixed, the mixture was fed at 4.0 to 8.0 kg/hr into a twin screw extruder (Leistritz ZSE 18 HP). Zones 1 through 8 were heated from 270° C. to 325° C. for sample 143B. Zones 1 through 8 were heated from 270 to 300° C. for sample 141H. Zones 1 through 8 were heated from 310° C. to 380° C. for sample 147D. The screw speed was kept constant at 250 rpm.

### Example 6: Mechanical and Thermal Properties of the FEP/LCP Compatibilized Blends

The mechanical and thermal properties of samples 143B, 147D, and 141H (shown in Table 6 above) were tested and compared to fully fluorinated FEP and LCP. Samples were gravity fed into a Sumitomo SE75DU injection molding machine. The rotating screw was heated from 304° C. to 327° C. The samples were molded into ASTM D638 Type V bars for tensile testing, ASTM D790 flexural bars for dynamic mechanical analysis (DMA), and 3 × 3 cm plaques for thermal mechanical analysis (TMA) testing.

Tensile tests were completed according to ASTM D638 using Type V tensile bars and an Instron machine model 3365. All samples were pulled at 10 mm/min until break. The BlueHill2 program was used to calculate Young’s modulus (YM), tensile strength, and elongation. Table 7 below shows the results of the tensile tests. The data represent the average of four tensile bars.

Samples 143B, 147D, and 141H also underwent testing to calculate flexural modulus, maximum flexure load, and flexure stress. All 3-point flexural tests were performed according to ASTM D790 using a calibrated Instron and injection molded ASTM D790 flexural bars. The samples were placed on top of two metal rollers 50 mm apart in the Instron. A rod was utilized to provide a load at a rate of 1.35 mm/min. The BlueHill2 computer program was used to calculate flexural modulus, maximum flexure load, and flexure stress at maximum flexure load. The results of these tests are shown in Table 7 below. All data represent one flexural bar.

TABLE 7

Mechanical Properties of FEP/LCP Compatibilized Blends

| Sample # | Young’s Modulus (MPa) | Max Tensile Strength (MPa) | Max Flexural Load (MPa) | Flexural Modulus (MPa) |
|---|---|---|---|---|
| LCP | 2197 | 86 | 166 | 7937 |
| Fully Fluorinated FEP | 219 | 17 | 21 | 166 |
| 143B | 790 | 20 | 27 | 1723 |
| 147D | 732 | 17 | 22 | 1303 |
| 141H | 903 | 23 | 51 | 1945 |

Samples 143B, and 147D also underwent testing to calculate the coefficient of thermal expansion (CTE). CTE was measured by a TA Instruments TMA Q400 using 2.0 to 3.0 µm samples cut from injection molded 3 × 3 cm plaques. Initial sample dimensions were measured using a Mitutoyo series 293 micrometer. All samples were run using the following method: 1: Force 0.100 N; 2: Equilibrate at 45.00° C.; 3: Mark end of cycle 0; 4: Ramp 10.00° C./min to 100.00° C.; 5: Isothermal for 5.00 min; 6: Mark end of cycle 1; 7: Ramp 10.00° C./min to 55.00° C.; 8: Mark end of cycle 2; 9: Ramp 5.00° C./min to 190.00° C.; 10: Mark end of cycle 3; 11: Jump to 30.00° C.; 12: End of method.

CTE, α, was calculated using the following equation:

$$α = \left(1 / {\text{L}}_{0}\right) ⋅ \left(Δ \text{L} / Δ \text{T}\right)$$

where L₀ represents the initial sample height at 25° C., ΔL represents the change in length in microns (µms), and ΔT represents the change in temperature in degrees Celsius (°C). All samples were measured at change (ΔT) of 5° C. The results of the CTE testing are shown in Table 8 below. All values reported are in the Z direction, perpendicular to the flow direction of the injection molded sample. [Table 8]

TABLE 8

Coefficient of Thermal Expansion for FEP/LCP Compatibilized Blends

| Mechanical Properties | Unit | Fully Fluorinated FEP | LCP | 143B | 147D |
|---|---|---|---|---|---|
| CTE @80° C. (Z Direction) | ppm | 183 | 115 | 76 | 116 |
| CTE @100° C. (Z Direction) | ppm | 211 | 170 | 145 | 132 |
| CTE @120° C. (Z Direction) | ppm | 214 | 88 | 182 | 126 |
| CTE @150° C. (Z Direction) | ppm | 222 | 88 | 219 | 145 |
| CTE @180° C. (Z Direction) | ppm | 269 | 174 | 294 | 173 |

As shown in Table 8, samples 143B and 147D show an improvement in CTE values when compared to the fully fluorinated FEP.

### Example 7: Preparation of PFA/LCP Reactive Polymer Compatibilizers

Sheared PFA, LCP, 6-Hydroxy-2-Naphthoic acid, and 4-Hydroxybenzoic acid were all added to one bag and mixed uniformly. Amounts of each chemical added are shown in Table 9. 6-Hydroxy-2-Napthoic Acid and 4-Hydroxybenzoic Acid, common LCP monomers, were both added at one to one molar equivalents and always totaled 5 wt % of all formulations. Sample 896C incorporated sheared LCP into the blend rather than the unsheared LCP used in samples 896A and 896B. Once the samples were thoroughly mixed, the mixture was fed at 4.0 to 6.0 kg/hr into a twin screw extruder (Leistritz ZSE 18 HP). Zones 1 through 8 were heated from 310° C. to 340° C. for each sample. Screw speed was keep constant at 250 rpm. All reactive polymer compatibilizer samples were obtained as brown pellets. [Table 9]

TABLE 9

Amounts of Chemicals Used in PFA/LCP Reactive Polymer Compatibilizer

| | | | | |
|---|---|---|---|---|
| Sample # | PFA | 6-Hydroxy-2-Naphthoic acid | 4-Hydroxybenzoic acid | LCP |
| 896A | 95% (950 g) | 2.89% (28.9 g) | 2.11% (21.1 g) | 0% |
| 896B | 90% (900 g) | 2.89% (28.9 g) | 2.11% (21.1 g) | 5% (50 g) |
| 896C | 85% (850 g) | 2.89% (28.9 g) | 2.11% (21.1 g) | 10% (100 g sheared) |

FIG. 4 shows the preparation of PFA/LCP reactive polymer compatibilizers by polycondensation in the Leistriz twin screw extrude. The reactive polymer compatibilizer formulations are displayed in Table 9. The step growth polycondensation is driven by the heat of the extruder. The HF produced by the PFA and/or sheared PFA serves a Lewis acid driving the reaction. Aromatic monomers 6-Hydroxy-2-Naphthic acid and 4-Hydroxybenzoic acid are common LCP monomers and are effective in lowering the interfacial tension between PFA and LCP. Due to 6-Hydroxy-2-Naphthoic acid and 4-Hydroxybenzoic acid being A-B type functional monomers, they both have the ability to polymerize with another molecule of the sample molecular structure or other monomer. The corresponding random copolymers, segments, monomers, and oligomers can react with the end groups of sheared PFA and/or LCP to produce a random block copolymer.

### Example 8: Preparation of PFA/LCP Compatibilized Blend

The initial compatibilization of PFA and LCP is shown in Table 10. Carbonyldiimidazole (CDI), LCP, PFA/LCP reactive polymer compatibilizer, and PFA were all added to one bag and mixed until homogeneous. The mixture was then fed at 4.0 to 6.0 kg/hr into a twin screw extruder (Leistritz ZSE 18 HP). Zones 1 through 8 were heated from 310 to 340° C. Screw speed was kept constant at 250 rpm. PFA/LCP compatibilized blends were all obtained as gray pellets. [Table 10]

TABLE 10

PFA/LCP Compatibilized Blends

| | | | | |
|---|---|---|---|---|
| Sample # | PFA | PFA/LCP Reactive Polymer Compatibilizer | CDI | LCP |
| 897A | 72.3% (1446 g) | 20% (400 g 896A) | 0.2% (4 g) | 7.5% (150 g) |
| 896B | 72.3% (1446 g) | 20% (400 g 896B) | 0.2% (4 g) | 7.5% (150 g) |
| 896C | 72.3% (1446 g) | 20% (400 g 896C) | 0.2% (4 g) | 7.5% (150 g) |

### Example 9: Injection Molded Samples for Mechanical Property Testing

Samples 897A, 897B, and 897C were gravity feed into a Sumitomo SE75DU injection molding machine. The feed zone was keep at 49° C. Zones 1 through 5, in the rotating screw, were heated from 310 to 340° C. Samples were molded into ASTM D638 Type V bars for tensile testing, ASTM D790 flexural bars for dynamic mechanical analysis (DMA), and 3 × 3 cm plaques for thermal mechanical analysis (TMA) testing.

All mechanical testing of the injection molded samples was carried out using Type V tensile bars. All tensile tests were completed according to ASTM D638 using Type V tensile bars using Instron machine model 3365. All samples were pulled at 10 mm/min until break. Bluehill 2 computer program was used to calculate Young’s modulus (YM), tensile strength, and elongation were recorded. All data represents the average of four tensile bars as shown in Table 11. [Table 11]

TABLE 11

Mechanical properties of PFA/LCP Compatibilized Blends

| Sample # | Young’s Modulus (MPa) | Max Tensile Strength (MPa) | Elongation (%) |
|---|---|---|---|
| LCP | 2197 | 86 | 147 |
| PFA | 219 | 17 | 231 |
| 897A | 619 | 21 | 8.9 |
| 897B | 826 | 20 | 7.7 |
| 897C | 709 | 18 | 18 |

Table 11 shows the tensile properties of blend samples 897A-C. Their exact formulations are shown in Table 10. Sample 897A displays the highest max tensile strength with a value of 21. While, sample 897B has the highest Young’s modulus (YM) of 826 MPa. All samples showed an increase in Young’s Modulus relative to PFA. Samples 897A and 897B only showed a slight improvement in max tensile strength when compared to PFA.

### Example 10: CTE Measurements of PFA/LCP Compatibilized Blends

The coefficient of thermal expansion (CTE) was measured by a TA Instruments TMA Q400 using 2.0 to 3.0 µm samples cut from injection molded 3 × 3 cm plaques. Initial sample dimensions were measured using a Mitutoyo series 293 micrometer. All samples were run using the following method: 1: Force 0.100 N; 2: Equilibrate at 45.00° C.; 3: Mark end of cycle 0; 4: Ramp 10.00° C./min to 100.00° C.; 5: Isothermal for 5.00 min; 6: Mark end of cycle 1; 7: Ramp 10.00° C./min to 55.00° C.; 8: Mark end of cycle 2; 9: Ramp 5.00° C./min to 190.00° C.; 10: Mark end of cycle 3; 11: Jump to 30.00° C.; 12: End of method.

CTE, α, was calculated using the following equation:

$$α = \left(1 / {\text{L}}_{0}\right) ⋅ \left(Δ \text{L} / Δ \text{T}\right)$$

where L₀ represents the initial sample height at 25° C., ΔL represents the change in length in microns (µms), and ΔT represents the change in temperature in degrees Celsius (°C). All samples were measured at change (ΔT) of 5° C. [Table 12]

TABLE 12

Coefficient of Thermal Expansion for FEP/LCP Compatibilized Blends

| Mechanical Properties | Unit | PFA | LCP | 897A | 897B | 897C |
|---|---|---|---|---|---|---|
| CTE @80° C. (Z Direction) | ppm | 74 | 115 | 166 | 165 | 86 |
| CTE @100° C. (Z Direction) | ppm | 150 | 170 | 183 | 182 | 138 |
| CTE @120° C. (Z Direction) | ppm | 193 | 88 | 109 | 109 | 141 |
| CTE @150° C. (Z Direction) | ppm | 217 | 88 | 258 | 128 | 177 |
| CTE @180° C. (Z Direction) | ppm | 260 | 174 | 301 | 117 | 240 |

Table 12 shows the coefficient of thermal expansion (CTE) of samples 897A-C, PFA, and LCP by TMA. CTE values for samples 897A and 897B are higher than the samples tested at 80° C. and 100° C. Samples 897C has the lowest CTE values at 80° C. and 100° C. At 120° C., 150° C., and 180° C. sample 897B has the lowest CTE of the compatibilized blends. At 180° C., the 897B has a CTE value of 117 which is lower than CTE value of LCP at 180° C.

### Example 11: Preparation of FP/PEI Reactive Polymer Compatibilizer Type I

In the current Example 11, reactive polymer compatibilizers 148B and 148C may be made by blending sheared perfluoroalkoxy alkane (PFA) or sheared fluorinated ethylene propylene (FEP) with 4,4′-(Hexafluoroisopropylidene) diphthalic anhydride (6FDA) and 2,6-diaminoanthraquinone until homogeneous. Sample 156B may be made by blending sheared PFA with 4,4′-(Hexafluoroisopropylidene) diphthalic anhydride (6FDA) and 4,4′oxydianiline. Sample 156C may be made by blending sheared PFA with norbornene dianhydride and 2,6-diaminoanthraquinone. The percentage of each chemical used in each sample is shown in Table 13. The sheared PFA or sheared FEP is made by processing commercial fluoropolymers using a high shear extruder. Sheared fluoropolymers increase the number of reactive end groups compared to commercial fluoropolymers. 4,4′-(Hexafluoroisopropylidene) diphthalic anhydride and 2,6-diaminoanthraquinone are both PEI monomers and were both added at one to one molar equivalents. [Table 13]

TABLE 13

Percentage of chemicals to make FP/PEI Reactive Polymer Compatibilizers

| Sample# | Sheared Fluoropolymer | 6FDA | Norbornene Dianhydride | 2,6-diaminoanthraquinone | 4,4′-oxydianiline |
|---|---|---|---|---|---|
| 148B | 95% FEP (950 g) | 3.25% (32.5 g) | 0% | 1.75% (17.5 g) | 0% |
| 148C | 95% PFA (950 g) | 3.25% (32.5 g) | 0% | 1.75% (17.5 g) | 0% |
| 156B | 95% PFA (950 g) | 3.25% (32.5 g) | 0% | 0% | 1.58% (15.8 g) |
| 156C | 95% PFA (950 g) | 0% | 2.48% (24.8 g) | 2.52% (25.2 g) | 0% |

Once each sample was thoroughly mixed, the mixture was fed at 4.0 to 6.0 kg/hr into a Leistritz ZSE-18 HP-PH twin screw extruder and the compound was extruded into pellet form. Zones 1 through 8 were heated from 270 to 290° C. for sample 148B. Zones 1 through 8 were heated from 280 to 355° C. for sample 148C. Zones 1 through 8 were heated from 310 to 360° C. for sample 156B and sample 156C. The screw speed was kept constant at 250 rpm.

### Example 12: Preparation of Fluoropolymer/PEI or TPI Compatibilized Blend

Compatibilized polymer blend formulations for the compatibilization of PFA or FEP fluoropolymer with polyetherimide (PEI) or thermoplastic polyimide (TPI) are shown in Table 14. For each sample, the formulation components shown in Table 14 were all added to one bag and mixed until homogenous. Samples 292A and 292B were compounded without the aid of a reactive polymer compatibilizer. The mixtures were then fed at 4.0 to 6.0 kg/hr into a Leistritz ZSE-18 HP-PH twin screw extruder and the compounds were extruded into pellet form. Zones 1 through 8 were heated from 270 to 320° C. for FEP compatibilized blends. Zones 1 through 8 were heated from 280 to 330° C. for PFA compatibilized blends. [Table 14]

TABLE 14

Percentage of chemicals utilized to compound FP/PEI compatibilized blends.

| Sample# | Fluoro-p olymer | Sheared Fluoro-pol ymer | PEI-Amine | PEI or TPI | Reactive Polymer Compatibilizer | 1,4-bis(4,5-dih ydro-2-oxazolyl )benzene |
|---|---|---|---|---|---|---|
| 150A | 61% FEP (1220 g) | 0% | 3% (60 g) | 15% (300 g) TPI | 20% 148B (400 g) | 1% (20 g) |
| 1450B | 71% PFA (1420 g) | 0% | 3% (60 g) | 15% (300 g) PEI | 10% 148C (200 g) | 1% (20 g) |
| 157B | 64.75% PFA (648 g) | 0% | 0% | 15% (150 g) TPI | 20% 156B (200 g) | 0.25% (2.5 g) |
| 157C | 64.75% PFA (648 g) | 0% | 0% | 15% (150 g) TPI | 20% 156 (200 g) | 0.25% (2.5 g) |
| 292A | 61 % FEP (1220 g) | 20% FEP (400 g) | 3% (60 g) | 15% (300 g) TPI | 0% | 1% (20 g) |
| 292B | 71% PFA (1420 g) | 10% PFA (200 g) | 3% (60 g) | 15% (300 g) PEI | 0% | 1% (20 g) |

### Example 13: Preparation of PFA/PEI Reactive Polymer Compatibilizer Using Sheared PFA

In the current example, a reactive polymer compatibilizer may be made by blending perfluoroalkoxy alkane (PFA), and a sheared PFA with 4,4′-(Hexafluoroisopropylidene) diphthalic anhydride, PEI-Amine, and 4,4′-Oxydianiline until homogeneous. The percentage of each chemical is shown in Table 15. The sheared PFA is made by processing commercial PFA using a high shear extruder. Sheared PFA has about 3-5 times the number of reactive end groups as commercial, unsheared, PFA. 4,4′-(Hexafluoroisopropylidene)diphthalic anhydride and 4,4′-oxydianilie are both PEI monomers.

TABLE 15

Percentage of chemicals used to make reactive polymer compatibilizer 161A.

| Sample # | Sheared PFA | 4,4′-(Hexafluoroisopropylidene) diphthalic Anhydride | 4,4′-Oxydianiline | PEI-Amine |
|---|---|---|---|---|
| 161A | 81.8% | 3.11% | 1.44% | 13.6 % |

Table 16 shows the compositions of polymer blend samples 162F and 292B. As previously discussed, reactive polymer compatibilizers, such as sample 161A, or other compatibilizing agents may be utilized to lower the surface tension between PEI or TPI with PFA. 1,4-Bis(4,5-dihydro-2-oxazolyl)benzene, a bis(oxazoline) compound, was used to react PEI and TPI to PFA. Reactive polymer compatibilizers, such as 161A, may further improve compatibility by increasing miscibility of PEI and TPI in PFA. Improved compatibility between the polymers can lead to improved processability. Polymer blend formulations for the compatibilization of PFA with PEI and TPI are shown in Table 16. Reactive polymer compatibilizer sample 161A, either PEI or TPI, 1,4-Bis(4,5-dihydro-2-oxazolyl)benzene and PFA were all added to one bag and mixed until homogeneous. The mixture was then fed at 2.0 to 6.0 kg/hr into a Leistritz ZSE-18 HP-PH twin screw extruder and the compound was extruded into pellet form. Zones 1 through 8 were heated from 350 to 390° C. Screw speed was kept constant at 250 rpm. PEI/PFA blends were obtained as slight yellow pellets.

TABLE 16

Formulations of compatibilized blends.

| Sample # | PFA | PEI or TPI | 161A | 1,4-Bis(4,5-dihydro-2-oxazolyl)benzene | PEI-Amine |
|---|---|---|---|---|---|
| 162F | 82.3% | 7.5% TPI | 10.0% | 0.25% | 0% |
| 292B | 81% | 15% PEI | 0% | 1% | 3% |

Sample 162F showed improved processing characteristics relative to 292B. Unlike sample 162F, sample 292B did not contain any reactive copolymer compatibilizer. As shown in FIG. 5, pellets formed from sample 292B were rough, non-uniform, and contained unmelts. The pellets formed from sample 162F were smooth and contain substantially no unmelts. The pellets formed from sample 162F appear to be well blended. With the addition of the reactive copolymer compatibilizer 161A, the feed rate was improved from 2.0 kg/hr for 292B to 6.0 kg/hr for 162F. FIG. 6 shows a potential reaction for the preparation of a PEI/PFA reactive polymer compatibilizer blend by polycondensation in a Leistriz twin screw extruder. In this embodiment, the polycondensation is driven by the heat of the extruder. The HF produced by the sheared PFA serves as a Lewis acid driving the reaction. As shown in FIG. 6, a reactive polymer compatibilizer, such as, for example, sample 161A, may be prepared as a random block copolymer using 4,4-Oxydianiline, 4,4′-(Hexafluoroisopropylidene) diphthalic anhydride, and PEI-amine. In some embodiments, a reactive polymer compatibilizer is effective in lowering the interfacial tension between PFA and PEI or TPI. Monomers, 4,4′-Oxydianiline and 4,4′-(Hexafluoroisopropylidene) diphthalic anhydride serve as effective chain extenders for the larger polymers of sheared PFA and PEI-Amine. The corresponding block copolymers, monomers, and oligomers may be reacted to form imide and amide bonds leading to a new random block copolymer reactive polymer compatibilizer as shown in FIG. 6.

### Example 14: Preparation of PFA/PAEK Reactive Polymer Compatibilizer

In the current Example 14, reactive polymer compatibilizers may be made by blending sheared perfluoroalkoxy alkane (PFA) with 4-aminobenzoic acid and polyaryle ether ketones (PAEK) in either the commercial or sheared form. The sheared PFA and sheared PAEK are made by processing commercial fluoropolymers using a high shear extruder. Sheared fluoropolymers increase the number of reactive end groups compared to un-sheared fluoropolymers. The percentage of each chemical for reactive polymer compatibilizer samples 162G and 162H are shown in Table 17. 4-aminobenzoic acid is a monomer of both PAEK and PEEK. 4-aminobenzoic acid and was used in total for 5 wt.% of the final blend.

TABLE 17

Percentage of chemicals utilized to make PAEK/PFR Reactive Polymer Compatibilizer

| Sample # | Sheared PFA | 4-aminobenzoic acid | PAEK | Sheared PAEK |
|---|---|---|---|---|
| 162G | 90% | 5% | 5% | 0% |
| 162H | 5% | 5% | 0% | 90% |

As previously discussed, reactive polymer compatibilizers, such as sample 162H, or other compatibilizing agents may be utilized to lower the surface tension between a secondary engineering polymer with PFA. Compatibilized polymer blend formulations of PFA with PEEK were extruded through a twin screw extruder. The PFA/PEEK polymer blends were obtained as taupe pellets. Sample 09A is a PFA/PEEK blend with no reactive polymer compatibilizer. Sample 39E is a PFA/PEEK blend with a reactive polymer compatibilizers.

Tensile tests were completed according to ASTM D638 using Type V tensile bars and an Instron machine model 3365. All samples were pulled at 10 mm/min until break. The BlueHill2 program was used to calculate Young’s modulus (YM), tensile strength, and elongation. Table 18 below shows the results of these tensile tests. The data shown for Young’s modulus (YM), tensile strength, and elongation represent the average of five tensile bars.

Samples 09A and 39E also underwent testing to calculate flexural modulus, maximum flexure load, and flexure stress. All 3-point flexural tests were performed according to ASTM D790-03 using a calibrated Instron and injection molded ASTM D790 flexural bars. The samples were placed on top of two metal rollers 50 mm apart in the Instron. A rod was utilized to provide a load at a rate of 1.35 mm/min. The BlueHill2 computer program was used to calculate flexural modulus and flexural stress at maximum flexure load. The results of these tests are shown in Table 18 below. All data shown for flexural modulus and flexural stress at maximum flexure load represent three flexural bars. [Table 18]

TABLE 18

Mechanical properties of PEEK/PFA compatibilized blends

| Sample # | Young’s Modulus (MPa) | Max Tensile Strength (MPa) | Elongation (%) | Max Flexural Stress (MPa) | Flexural Modulus (MPa) |
|---|---|---|---|---|---|
| PFA | 100 | 26.4 | 478 | 10.7 | 462 |
| PEEK | 486 | 110 | 338 | 121 | 2923 |
| 09A | 396 | 75.2 | 229 | 109 | 2770 |
| 39E | 420 | 71.3 | 166 | 103 | 2603 |

The mechanical property data shown in Table 18 show that the addition of a reactive polymer compatibilizer during reactive extrusion increases the overall compatibility of the two polymers within the system. The modulus of the sample 39E is increased with the addition of the reactive polymer compatibilizer. There is little change to the flexural properties between the 09A and 39E blends.

Samples 09A and 39E as well as PFA and PEEK were tested for thermal stability through thermogravimetric analysis (TGA). For the thermal stability protocol, the TGA furnace was purged with continuous flowing nitrogen gas at a rate of 10 mL/min. The TGA furnace program was set to heat from room temperature (15-30° C., but preferably 23° C.) up to 800° C. at a 10° C./min temperature ramp. The TGA recorded the weight of the sample over time as the sample was heated. When the heating cycle was complete, the pan with any remaining material was removed from the furnace. The 1.0%, and 5.0% weight loss points were examined and recorded using TA Universal Analysis software. The 1% and 5% weight loss temperatures of each polymer and blend are shown in Table 19 below.

TABLE 19

Thermal properties of PEEK/PFA Compatibilized Polymer Blends

| Sample # | 1% wt. Loss Temperature (°C) | 5% wt. Loss Temperature (°C) |
|---|---|---|
| PFA | 465 | 504 |
| PEEK | 554 | 573 |
| 09A | 388 | 547 |
| 39E | 454 | 539 |

Sample 09A, which does not include any reactive polymer compatibilizer, has a 1% wt. loss temperature at 388° C. This temperature is much lower than the individual polymers that make up the blend, namely PFA and PEEK. Without being bound by theory, it is believed this low weight loss temperature is due to small molecules or oligomers that did not react to form copolymers during the reactive extrusion. When a reactive polymer compatibilizer is added into the system, as in sample 39E, the 1% wt. loss temperature increases to 454° C. The reactive polymer compatibilizer aids in the thermal stability of the compatibilized fluoropolymer blend.

### Example 15: Preparation of PFA/COC Reactive Polymer Compatibilizers

In the current Example 15, a reactive complier compatibilizer, Sample 52A, may be made by blending sheared perfluoroalkoxy alkane (PFA) with 4,4-diaminodiphenyl ether, Bicyclo[2.2.2]oct-7-ene-2,3,5,6-tetracarboxylic Dianhydride, and a cyclic olefin copolymer (COC). The amount of each chemical used in shown in Table 20. The sheared PFA is made by processing commercial fluoropolymers using a high shear extruder. Sheared fluoropolymers increase the number of reactive end groups compared to commercial fluoropolymers. Bicyclo[2.2.2]oct-7-ene-2,3,5,6-tetracarboxylic Dianhydride and 4,4-diaminophenyl ether were used to graft onto the cyclic olefin copolymer. The monomers were used to create new end groups for further compatibilization between the PFA and COC. The methods discussed in this example are not limited to PFA but can be apply to other fluoropolymers including, for example, FEP.

TABLE 20

Percentage of chemicals used in PFA/COC reactive polymer compatibilizer

| Sample # | Sheared PFA | Cyclic Olefin Copolymer | 4,4-diaminodiphenyl ether | Bicyclo[2.2.2]oct-7-ene-2,3,5,6-tetracarboxylic Dianhydride |
|---|---|---|---|---|
| 52A | 81.0% | 14.5% | 2.0% | 2.5% |

### Example 16: Preparation of FEP/PPO Compatibilized Copolymers and FEP/PPO Compatibilized Blends

In the current Example 16, a reactive polymer compatibilizer, Sample AWA-G, may be made by blending sheared Fluorinated Ethylene Propylene copolymer (FEP) with 6FDA, 4,4′-oxydianiline and a poly(phenylene) oxide (PPO). The amounts of each chemical used are shown in Table 21. The sheared FEP is made by processing commercial fluoropolymers using a high shear extruder. Sheared fluoropolymers increase the number of reactive end groups compared to commercial fluoropolymers. 6FDA and 4,4′-oxydianiline are monomers and are used to create new end groups for further compatibilization between the FEP and PPO. The methods shown in this example are not limited to FEP but may be applied to other fluoropolymers including, for example, PFA.

TABLE 21

Percentages of chemicals used for FEP/PPO reactive polymer compatibilizer

| Sample # | Sheared FEP | PPO | 6FDA | 4,4′-oxydianiline |
|---|---|---|---|---|
| AWA | 92% | 5.7% | 1.6% | 0.7% |
| AWC | 92% | 5.2% | 1.5% | 1.3% |
| AWD | 92% | 6.7% | 0.9% | 0.4% |
| AWE | 92% | 4.4% | 2.5% | 1.1% |
| AWF | 92% | 7.1% | 0% | 0.9% |
| AWG | 92% | 8% | 0% | 0 |

Those skilled in the art will recognize improvements and modification to the preferred embodiments of the present disclosure. All such improvements and modifications are considered within the scope of the concepts disclosed herein and the claims that follow. It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described herein above are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

1. A reactive compatibilizer composition comprising:
(a) a functional fluoropolymer;
(b) a first functional monomer; and
(c) a functional non-fluoropolymer;
wherein the reactive compatibilizer composition is a block copolymer comprising a functional fluoropolymer segment and a functional non-fluoropolymer segment.

2. The reactive compatibilizer composition of claim 1, further comprising a second functional monomer or a functional oligomer.

3. The reactive compatibilizer composition of claim 1, wherein the functional fluoropolymer includes a functional group selected from the group consisting of a carboxylic acid, amine, hydroxyl, epoxy, unsaturated (vinyl), and carbonyl fluoride functional groups.

4. The reactive compatibilizer composition of claim 1, wherein the first functional monomer includes a functional group selected from the group consisting of a carboxylic acid, amine, hydroxyl, and epoxy end groups.

5. The reactive compatibilizer composition of claim 1, wherein the first functional monomer is di, tri, or tetra functional.

6. The reactive compatibilizer composition of claim 1, wherein the functional fluoropolymer is mechanically sheared.

7. The reactive compatibilizer composition of claim 1, wherein the functional fluoropolymer is a perfluoroalkoxy alkane (PFA) or a fluorinated ethylene propylene (FEP).

8. The reactive compatibilizer composition of claim 1, wherein the functional non-fluoropolymer is a polyetherimide (PEI) or thermoplastic polyimide (TPI).

9. The reactive compatibilizer composition of claim 1, wherein the functional non-fluoropolymer is polyaryle ether ketones (PAEK) or poly ether ether ketone (PEEK).

10. The reactive compatibilizer composition of claim 1, wherein the functional non-fluoropolymer is a cyclic olefin copolymer (COC).

11. A compatibilized polymer blend comprising a fluoropolymer, non-fluoropolymer, and a reactive polymer compatibilizer, wherein the reactive polymer compatibilizer is a block-copolymer including a fluoropolymer block and a non-fluoropolymer block.

12. The compatibilized polymer blend of claim 11, wherein the fluoropolymer is a perfluoroalkoxy alkane (PFA) or a fluorinated ethylene propylene (FEP).

13. The compatibilized polymer blend of claim 11, wherein the non-fluoropolymer is a polyetherimide (PEI) or thermoplastic polyimide (TPI).

14. The compatibilized polymer blend of claim 11, wherein the non-fluoropolymer is a polyaryle ether ketones (PAEK) or poly ether ether ketone (PEEK).

15. The compatibilized polymer blend of claim 11,wherein the non-fluoropolymer is a Polyphenylene Oxide (PPO) polymer or a Cyclic Olefin (COC) polymer.

16. The compatibilized polymer blend of claim 11, comprising at least about 80% fluoropolymer and wherein the fluoropolymer is a perfluoroalkoxy alkane (PFA).

17. A method of forming a reactive polymer compatibilizer comprising:
reacting a functional fluoropolymer, a first functional monomer, and a functional non-fluoropolymer within an extruder to form a reactive polymer compatibilizer.

18. The method of claim 17, further comprising reacting a functional oligomer within an extruder.

19. The method of claim 17, further comprising extruding the reactive polymer compatibilizer.

20. The method of claim 17, further comprising forming pellets of the reactive polymer compatibilizer.
